(19) United States
(12) Patent Application Publication
(10) Pub. No.: US 2025/0175858 A1
(43) Pub. Date: May 29, 2025

(54) RATE CONTROL METHOD AND DEVICE WITH LOW POWER CONSIDERATION FOR WIRELESS DENSE NETWORKS

(71) Applicant: MEDIATEK INC., Hsinchu City (TW)

(72) Inventors: Po-Chi CHEN, Hsinchu City (TW); Ying-You LIN, Hsinchu City (TW); Ren-Fang GAN, Hsinchu City (TW)

(21) Appl. No.: 18/960,087

(22) Filed: Nov. 26, 2024

Related U.S. Application Data
(60) Provisional application No. 63/603,145, filed on Nov. 28, 2023.

(51) Int. Cl. H04W 28/20; H04W 28/02; H04W 52/36

(52) U.S. Cl. CPC H04W 28/20; H04W 28/0268; H04W 52/365

(57) ABSTRACT

A rate control method with low power consideration for wireless dense networks is provided. The rate control method is implemented by a wireless communication device. The rate control method includes determining first power needed for transmission of an additional overhead of data traffic; determining a plurality of second powers needed for transmission of the data traffic, wherein the plurality of second powers correspond to a plurality of data rates of the data traffic; selecting a data rate from the plurality of data rates based on the first power, the plurality of second powers and a plurality of packet error rates (PERs) that correspond to the plurality of data rates; and transmitting a physical protocol data unit (PPDU), wherein the PPDU comprises the data traffic, and the data traffic is transmitted at the selected data rate.

### CROSS REFERENCE TO RELATED APPLICATIONS

This application claims the benefit of U.S. Provisional Application No. 63/603,145, entitled “Rate Control Mechanism with Low Power Consideration for Wireless Dense Network”, filed on Nov. 28, 2023, the entirety of which is incorporated by reference herein.

### BACKGROUND OF THE INVENTION

### Field of the Invention

The present disclosure generally relates to the field of wireless communication technologies. More specifically, aspects of the present disclosure relate to a rate control method and a rate control device with low power consideration for wireless dense networks.

### Description of the Related Art

Most rate control algorithms or rate control mechanisms are currently based on packet error rate (PER) or channel response. The goal of these rate control algorithms or rate control mechanisms is to optimize effective bitrate, not low power consumption. Therefore, a small amount of traffic transmitted between devices may result in a large amount of power consumption. Furthermore, these rate control algorithms or rate control mechanisms do not consider media access control (MAC)/power efficiency and may result in large retransmission power consumption in dense networks.

Therefore, there is a need for rate control methods and rate control devices with low power consideration for wireless dense networks to solve these problems.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

In an exemplary embodiment, a rate control method with low power consideration for a wireless network is provided. The rate control method is implemented by a first device. The rate control method comprises building a connection with a second device by using a first 802.11 protocol. The rate control method comprises determining whether pending data traffic is large data traffic or small data traffic. The rate control method comprises transmitting a first physical protocol data unit (PPDU) compliant with the first 802.11 protocol to the second device in response to determining that the pending data traffic is large data traffic, wherein the first PPDU comprises a preamble that is compliant with the first 802.11 protocol and the large data traffic. The rate control method comprises transmitting a second PPDU compliant with a second 802.11 protocol to the second device in response to determining that the pending data traffic is small data traffic, wherein the second PPDU comprises a preamble that is compliant with the second 802.11 protocol and the small data traffic, wherein a duration of the preamble that is compliant with the second 802.11 protocol is shorter than a duration of the preamble that is compliant with the first 802.11 protocol.

In some embodiments, the first PPDU is an extremely high throughput (EHT) PPDU or a high efficiency (HE) PPDU, and the second PPDU is a very high throughput (VHT) PPDU. The first 802.11 protocol is 802.11ax or 802.11be, and the second 802.11 protocol is 802.11ac

In some embodiments, a duration of a long training field (LTF) field in the HE PPDU or the EHT PPDU is longer than a duration of a LTF field in the VHT PPDU.

In some embodiments, the HE PPDU or the EHT PPDU has a packet extension, and the VHT PPDU does not have a packet extension.

In some embodiments, the step of determining whether the pending data traffic is large data traffic or small data traffic further comprises: determining a ratio of a calculated length of a PPDU to a predefined PPDU maximum length, wherein the PPDU comprises the pending data traffic and a PPDU preamble, and the PPDU is compliant with the first 802.11 protocol or the second 802.11 protocol; comparing the ratio with a threshold; determining that the pending data traffic is large data traffic when the ratio is greater than the threshold; and determining that the pending data traffic is small data traffic when the ratio is less than or equal to the threshold.

In an exemplary embodiment, a rate control method with low power consideration for a wireless network is provided. The rate control method is implemented by a wireless communication device. The rate control method comprises determining first power needed for transmission of an additional overhead of data traffic, wherein the additional overhead comprises an additional control signal required to complete a transmission of the data traffic. The rate control method comprises determining a plurality of second powers needed for transmission of the data traffic, wherein the plurality of second powers correspond to a plurality of data rates of the data traffic. The rate control method comprises selecting a data rate from the plurality of data rates based on the first power, the plurality of second powers and a plurality of packet error rates (PERs) that correspond to the plurality of data rates. The rate control method comprises transmitting a physical protocol data unit (PPDU), wherein the PPDU comprises the data traffic, and the data traffic is transmitted at the selected data rate.

In some embodiments, the step of selecting a data rate from the plurality of data rates based on the first power, the plurality of second powers and the plurality of PERs that correspond to the plurality of data rates further comprises: determining a plurality of total power consumptions corresponding to the plurality of data rates based on the first power, the plurality of second powers and the plurality of PERs that correspond to the plurality of data rates; and selecting the data rate that corresponds to a lowest total power consumption from the plurality of total power consumptions.

In some embodiments, the overhead comprises a request-to-send (RTS) and a preamble of the PPDU.

In some embodiments, the power needed for transmission of the RTS is a product of a duration of the RTS and transmission power of the RTS, the power needed for transmission of the preamble of the PPDU is a product of a duration of the preamble and transmission power of the preamble. The first power needed for transmission of the additional overhead is the sum of the power needed for transmission of the RTS and the power needed for transmission of the preamble of the PPDU.

In some embodiments, the rate control method further comprises determining actual power for transmitting the data traffic based on a channel condition, wherein the data traffic in the PPDU is transmitted by using the actual power.

In some embodiments, the PPDU comprises a number of spatial streams (NSS) field, a modulation and coding scheme (MCS) field, a bandwidth (BW) field, and a guard interval/long training field (GI/LTF) field. At least one of the NSS field, the MCS field, the BW field and the GI/LTF field indicates the selected data rate.

In an exemplary embodiment, a rate control device with low power consideration for wireless dense networks is provided. The rate control device comprises a processor and a transceiver. The transceiver is operable to perform wireless transmission. The processor is operable to build a connection with a second device by using a first 802.11 protocol. The processor is operable to determine whether pending data traffic is large data traffic or small data traffic. The processor is operable to transmit a first physical protocol data unit (PPDU) compliant with the first 802.11 protocol to the second device in response to determining that the pending data traffic is large data traffic, wherein the first PPDU comprises a preamble that is compliant with the first 802.11 protocol and the large data traffic. The processor is operable to transmit a second PPDU compliant with a second 802.11 protocol to the second device in response to determining that the pending data traffic is small data traffic, wherein the second PPDU comprises a preamble that is compliant with the second 802.11 protocol and the small data traffic. A duration of the preamble that is compliant with the second 802.11 protocol is shorter than a duration of the preamble that is compliant with the first 802.11 protocol.

In an exemplary embodiment, a rate control device with low power consideration for wireless dense networks is provided. The rate control device comprises a processor and a transceiver. The transceiver is operable to perform wireless transmission. The processor is operable to determine first power needed for transmission of an additional overhead of data traffic, wherein the additional overhead comprises an additional control signal required to complete a transmission of the data traffic. The processor is operable to determine a plurality of second powers needed for transmission of the data traffic, wherein the plurality of second powers correspond to a plurality of data rates of the data traffic. The processor is operable to select a data rate from the plurality of data rates based on the first power, the plurality of second powers and a plurality of packet error rates (PERs) that correspond to the plurality of data rates. The processor is operable to transmit a physical protocol data unit (PPDU), wherein the PPDU comprises the data traffic, and the data traffic is transmitted at the selected data rate.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 illustrates an example network environment in which various solutions and schemes in accordance with the present disclosure.

FIG. 2 illustrates simplified block diagrams for the wireless communication entity and the wireless communication entity in accordance with the present disclosure.

FIG. 3 is a schematic diagram illustrating how the rate controller selects a rate in accordance with the present disclosure.

FIG. 4 is a flow chart illustrating the rate control method with low power consideration for wireless dense networks according to an embodiment of the disclosure.

FIG. 5 illustrates an EHT MU PPDU format, a HE SU PPDU format, a HE MU PPDU format and a VHT PPDU format according to an embodiment of the disclosure.

FIG. 6 is a flow chart illustrating the rate control method with low power consideration for wireless dense networks according to an embodiment of the disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

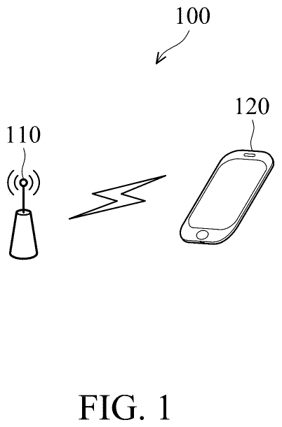

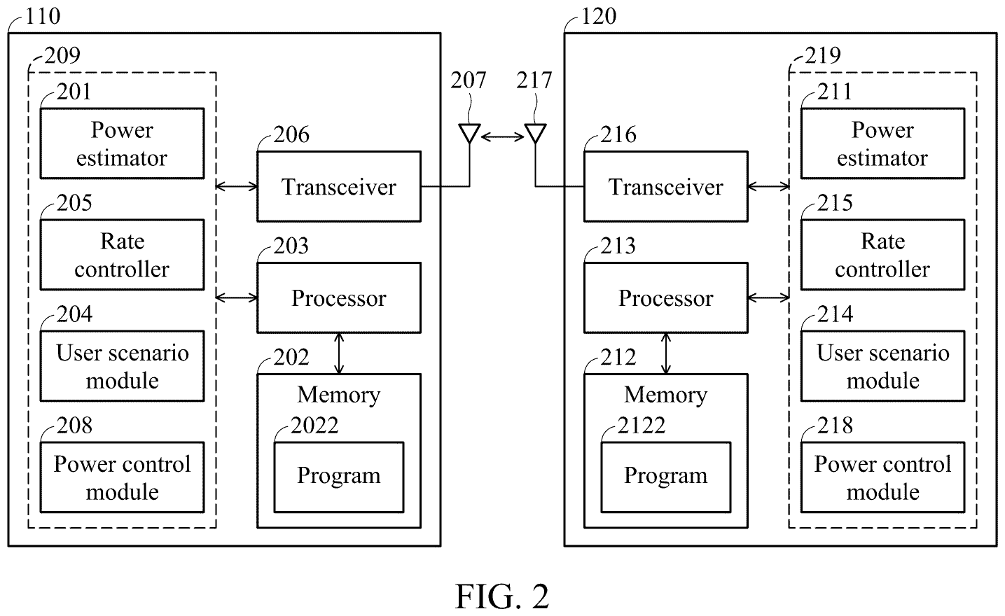

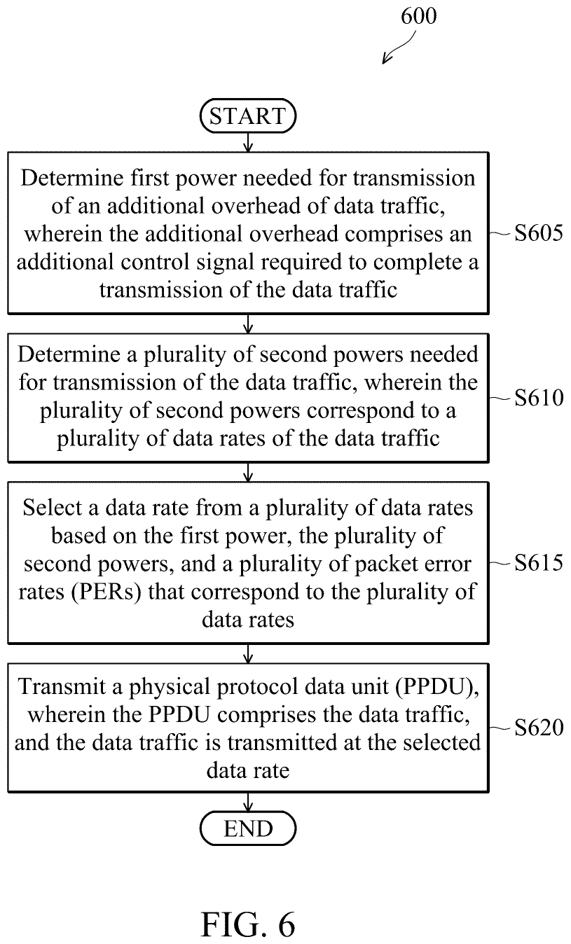

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, the network environment 100 may involve a wireless communication entity 110 and a wireless communication entity 120 communicating wirelessly in a wireless network in accordance with one or more Institute of Electrical and Electronics Engineers (IEEE) 802.11 standards. For instance, the wireless communication entity 110 may be an access point (AP) that provides Wi-Fi radio access and the wireless communication entity 120 may be a station (STA). Under various proposed schemes in accordance with the present disclosure, the wireless communication entity 110 and the wireless communication entity 120 may be configured to perform rate control according to various proposed schemes described herein.

FIG. 2 illustrates simplified block diagrams for the wireless communication entity 110 and the wireless communication entity 120 in accordance with the present disclosure. For the wireless communication entity 110, an antenna 207 transmits and receives RF signals. A RF transceiver module 206, coupled with the antenna 207, receives RF signals from the antenna 207, processes them and sends the processed signals to a processor 203. The RF transceiver module 206 also receives signals from the processor 203, processes them and sends the processed signals to the antenna 207. The processor 203 processes the received signals and invokes different functional modules to perform features in the wireless communication entity 110. A memory 202 stores program instructions and data 208 to control the operations of the wireless communication entity 110.

Similar configuration exists in the wireless communication entity 120 where an antenna 217 transmits and receives RF signals. A RF transceiver module 216, coupled with the antenna 217, receives RF signals from the antenna 217, processes them and sends the processed signals to a processor 213. The RF transceiver module 216 also receives signals from the processor 213, processes them, and sends the processed signals to the antenna 217. The processor 213 processes the received signals and invokes different functional modules to perform features in the wireless communication entity 120. A memory 212 stores program instructions and data 218 to control the operations of the wireless communication entity 120.

The wireless communication entities 110 and 120 also include several functional modules to carry out some embodiments of the present disclosure. The different functional modules are circuits can be configured and implemented by software, firmware, hardware, or any combination thereof. The function modules, when executed by the processors 203 and 213 (e.g., via executing program codes 208 and 218), for example, allow the wireless communication entity 110 to transmit data traffic to or receive data traffic from the wireless communication entity 120. A link adaptation module 209/219 comprises a power estimator 201/211, a user scenario module 204/214, a rate controller 205/215, a power control module 208 and/or a power control module 218.

In some embodiments, the power estimator 201/211 is used to estimate, for example, the power for additional overhead and the power for PPDU data, wherein the additional overhead is an additional control signal required to complete the transmission of PPDU data traffic, comprising a request-to-send (RTS), a clear-to-send (CTS), a preamble of the PPDU, an acknowledgement (ACK), or a block ACK. In one embodiment, the additional overhead comprises the RTS and the preamble of the PPDU. RTS may be Multi-User RTS or other types of RTS. In an alternative embodiment, the additional overhead only comprises the preamble of the PPDU.

The user scenario module 204/214 determines a data traffic type, wherein the data traffic type indicates that the data traffic is small amount of data (e.g., periodic data) or large amount of data (e.g., bursty data).

The rate controller 205/215 may select a data rate from a plurality of data rates according to the following formulas:

$${min}_{x ∈ a set of x} ( 1 + PER ( x ) ) \cdot ( {T}_{overhead} \cdot {P}_{overhead} + {T}_{data} ( x ) \cdot {P}_{data} ) \qquad ( 1 )$$

$${min}_{x ∈ a set of x} ( 1 + PER ( x ) ) \cdot ( {\sum }_{f ∈ a set of overheads} {T}_{f} \cdot {P}_{f} + \frac{Data traffic}{R ( x )} \cdot {P}_{data} ) \qquad ( 2 )$$

wherein R(x) is the data rate corresponding to x, wherein x denotes the set of parameters that affect the rate. The x denotes a combination of a plurality of parameters that comprises one or more of the following: the modulation and coding scheme (MCS), the number of spatial streams (NSS), the bandwidth (BW), the guard interval (GI), and the long training field (LTF). PER is the packet error rate of PPDU data traffic. T_{overhead} is the duration of the additional overhead, wherein the additional overhead is an additional control signal required to complete the transmission of PPDU data traffic. P_{overhead} is the transmission power of the additional overhead. T_{data}(x) is the duration of the data traffic corresponding to x. P_{data} is the power of the data traffic.

In one embodiment, the set of overheads comprise the RTS and the preamble of the PPDU.

$${\sum }_{f ∈ a set of overheads} {T}_{f} \cdot {P}_{f} = {T}_{RTS} \cdot {P}_{RTS} + {T}_{preamble} \cdot {P}_{preamble} .$$

In an alternative embodiment, the set of overheads only comprise the preamble of the PPDU.

$${\sum }_{f ∈ a set of overheads} {T}_{f} \cdot {P}_{f} = {T}_{preamble} \cdot {P}_{preamble}$$

In some embodiments, the data rate of the preamble is constant. If the data traffic has a higher rate, the RTS also has a higher rate. If the data traffic has a lower rate, the RTS also has a lower rate. In an alternative embodiment, the rate of the RTS may be constant.

The rate controller 205/215 selects a data rate from the plurality of data rates based on the duration of the additional overhead of the data traffic, the transmission power of the additional overhead, the duration of the data traffic, the power of the data traffic, and the plurality of PERs that correspond to the plurality of data rates. Specifically, the rate controller 205/215 determines a plurality of total power consumptions corresponding to the plurality of data rates based on the duration of the additional overhead of the data traffic, the transmission power of the additional overhead, the duration of the data traffic, the power of the data traffic, and the plurality of PERs that correspond to the plurality of data rates. Then, the rate controller 205/215 selects the lowest total power consumption from the plurality of total power consumptions and selects the data rate that corresponds to the lowest total power consumption. The rate controller 205/215 generates an indication, which indicates the selected data rate and the lowest total power consumption for transmitting the data traffic.

In some embodiments, the rate controller 205/215 may further determine the actual power for transmitting the data traffic based on a channel condition. When the rate controller 205/215 determines that the channel condition is perfect, low power may be used for transmitting the data traffic. When the rate controller 205/215 determines that the channel condition is bad, high power may be used for transmitting the data traffic, wherein the high power should meet requirement of the minimum signal to noise ratio (SNR) corresponding to the selected data rate. The rate controller 205/215 may generate the indication for indicating the actual power for transmitting the data traffic based on the channel condition.

The power control module 208/218 uses the selected data rate and the power indicated by the rate controller 205/215 to transmit the data traffic.

In some embodiments, the data traffic may be data or a management frame.

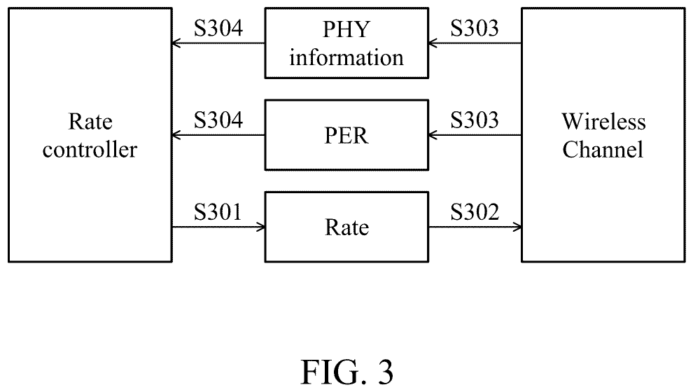

FIG. 3 is a schematic diagram illustrating how the rate controller selects a set of parameters x in accordance with the present disclosure.

As shown in FIG. 3, the rate controller first selects a parameter x in step S301, and the power control module transmits the data traffic by using a rate corresponding to the parameter x through a wireless channel in step S302. The rate controller then collects the PER and physical layer (PHY) information over the wireless channel under the condition of using the rate corresponding to the parameter x in step S303, wherein the PHY information may comprise information of current physical channel, e.g. channel qualities (such as SNR), channel characteristics (such as static or fading channel), whether the channel has interference or not, etc., which gives some indications of how the PER performance has performed. The rate controller selects a set of possible parameters x based on the parameter x, the PER and the PHY information corresponding to the parameter x in step S304. The selected set of possible parameters x are used in the formula (2).

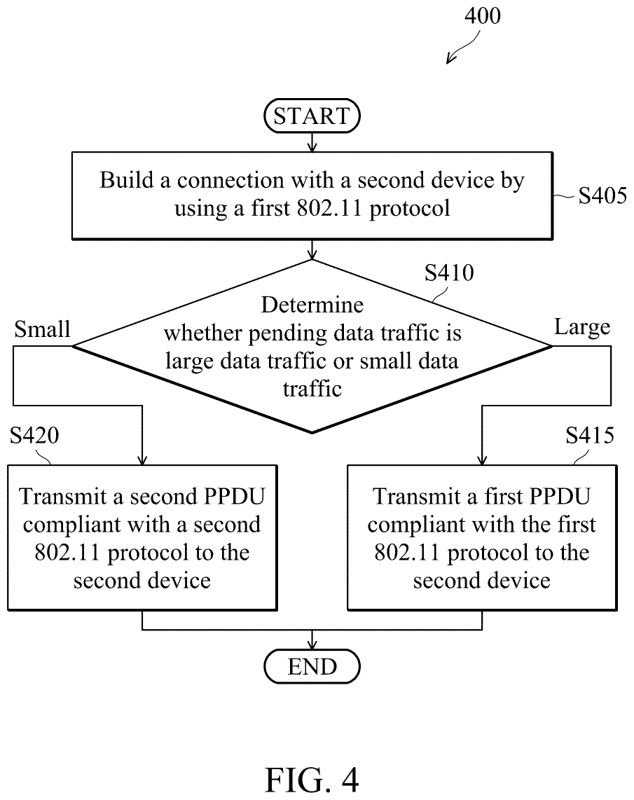

FIG. 4 is a flow chart 400 illustrating the rate control method with low power consideration for wireless dense networks according to an embodiment of the disclosure with reference to FIG. 2. The rate control method is implemented by a processor of a first device, wherein the first device may be one of the communication entities 110 and 120.

In step S405, the processor builds a connection with a second device by using a first 802.11 protocol.

Then, in step S410, the processor determines whether pending data traffic is large data traffic or small data traffic. The data traffic may be data or a management frame. Specifically, the processor determines the ratio of the calculated length of the PPDU to the predefined PPDU maximum length, wherein the PPDU comprises the pending data traffic and a PPDU preamble, and the PPDU is compliant with the first 802.11 protocol. Then, the processor determines that the pending data traffic is large data traffic when the ratio is greater than the threshold, and determines that the pending data traffic is small data traffic when the ratio is less than or equal to the threshold. In another embodiment, the predefined PPDU maximum length is 5.484 ms.

Next, in response to determining that the pending data traffic is large data traffic (“Large” in step S410), in step S415, the processor transmits a first physical protocol data unit (PPDU) compliant with the first 802.11 protocol to the second device, wherein the first PPDU comprises a preamble that is compliant with the first 802.11 protocol and the large data traffic.

Back to step S410, in response to determining that the pending data traffic is small data traffic (“Small” in step S410), in step S425, the processor transmits a second PPDU compliant with a second 802.11 protocol to the second device, wherein the second PPDU comprises a preamble that is compliant with the second 802.11 protocol and the small data traffic.

In one embodiment, the duration of the preamble that is compliant with the second 802.11 protocol is shorter than the duration of the preamble that is compliant with the first 802.11 protocol.

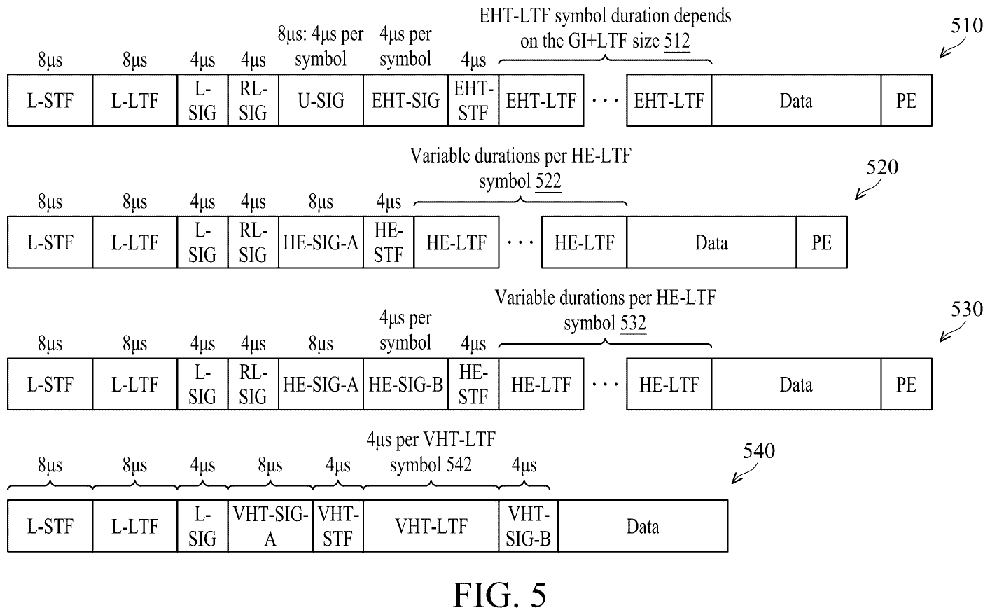

In one embodiment, the first PPDU is an extremely high throughput (EHT) PPDU or a high efficiency (HE) PPDU, and the second PPDU is a very high throughput (VHT) PPDU. FIG. 5 illustrates an EHT MU PPDU format 510, a HE SU PPDU format 520, a HE MU PPDU format 530 and a VHT PPDU format 540 according to an embodiment of the disclosure. As shown in FIG. 5, the durations of the long training field (LTF) fields 512, 522, and 532 in the EHT MU PPDU format 510, the HE SU PPDU format 520 and the HE MU

PPDU format 530 are greater than the duration of a LTF field 542 in the VHT PPDU format 540. In addition, the EHT MU PPDU format 510, the HE SU PPDU format 520 or the HE MU PPDU format 530 have packet extension (PE), and the VHT PPDU format 540 does not have a packet extension. In some embodiments, GI Length in the EHT MU PPDU format 510, the HE SU PPDU format 520 or the HE MU PPDU format 530 is larger than GI Length in VHT PPDU format 540. In addition, the number of SIG-B or EHT-SIG symbols in the EHT MU PPDU format 510, the HE SU PPDU format 520 or the HE MU PPDU format 530 may be an integer larger than 1. The VHT PPDU format 540 have one SIG-B symbol. In addition, the EHT MU PPDU format 510, the HE SU PPDU format 520 or the HE MU PPDU format 530 has RL-SIG. The VHT PPDU format 540 have no RL-SIG.

In one embodiment, the first 802.11 protocol is 802.11ax or 802.11be, and the second 802.11 protocol is 802.11ac.

In the rate control method and the rate control device with low power consideration for wireless dense networks provided in the embodiments of the present disclosure, since the VHT PPDU is used to transmit the pending data traffic when the pending data traffic is small data traffic, the purpose of reducing additional overhead can be effectively achieved.

FIG. 6 is a flow chart 600 illustrating the rate control method with low power consideration for wireless dense networks according to an embodiment of the disclosure with reference to FIG. 2. The rate control method is implemented by a processor of a wireless communication device, wherein the wireless communication device may be one of the communication entities 110 and 120.

In step S605, the processor determines first power needed for transmission of an additional overhead of data traffic, wherein the additional overhead comprises an additional control signal required to complete a transmission of the data traffic. The data traffic may be data or a management frame. The additional overhead may comprise a request-to-send (RTS) and a preamble of the PPDU. In an alternative embodiment, the additional overhead may only comprise a preamble of the PPDU.

In step S610, the processor determines a plurality of second powers needed for transmission of the data traffic, wherein the plurality of second powers correspond to a plurality of data rates of the data traffic.

Then, in step S615, the processor selects a data rate from a plurality of data rates based on the first power, the plurality of second powers, and a plurality of packet error rates (PERs) that correspond to the plurality of data rates. Specifically, the processor determines a plurality of total power consumptions corresponding to the plurality of data rates based on the first power, the plurality of second powers, and the plurality of PERs that correspond to the plurality of data rates. The processor selects the lowest total power consumption from the plurality of total power consumptions and selects the data rate that corresponds to the lowest total power consumption.

In step S620, the processor transmits a physical protocol data unit (PPDU), wherein the PPDU comprises the data traffic, and the data traffic is transmitted at the selected data rate.

In one embodiment, the step of determining first power needed for transmission of the additional overhead of data traffic further comprises: determining a plurality of first powers needed for transmission of the additional overhead corresponding to a plurality of rates; the step of determining the plurality of total power consumptions corresponding to the plurality of data rates based on the first power, the plurality of second powers and the plurality of PERs that correspond to the plurality of data rates further comprises: determining the plurality of total power consumptions corresponding to the plurality of data rates based on the plurality of first powers, the plurality of second powers and the plurality of PERs that correspond to the plurality of data rates.

In one embodiment, the first power needed for transmission of the additional overhead of data traffic is the product of the duration of the additional overhead and the transmission power of the additional overhead. For example, the power needed for transmission of the RTS is the product of the duration of the RTS and the transmission power of the RTS. The power needed for transmission of the preamble of the PPDU is the product of the duration of the preamble and the transmission power of the preamble.

In another embodiment, the processor may further determine the actual power for transmitting the data traffic based on a channel condition, wherein the data traffic in the PPDU is transmitted by using the actual power.

In some embodiments, the PPDU comprises a number of spatial streams (NSS) field, a modulation and coding scheme (MCS) field, a bandwidth (BW) field, and a guard interval/long training field (GI/LTF) field, wherein at least one of the NSS field, the MCS field, the BW field and the GI/LTF field indicates the selected data rate.

A person of ordinary skill in the art may be aware that, the units and steps in the examples described with reference to the embodiments disclosed herein may be implemented by electronic hardware, computer software, or a combination thereof. To clearly describe the interchangeability between the hardware and the software, the foregoing has usually described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A rate control method with low power consideration for a wireless network, wherein the rate control method is implemented by a first device, and comprises:
building a connection with a second device by using a first 802.11 protocol;
determining whether pending data traffic is large data traffic or small data traffic;
transmitting a first physical protocol data unit (PPDU) compliant with the first 802.11 protocol to the second device in response to determining that the pending data traffic is large data traffic, wherein the first PPDU comprises a preamble that is compliant with the first 802.11 protocol and the large data traffic; and
transmitting a second PPDU compliant with a second 802.11 protocol to the second device in response to determining that the pending data traffic is small data traffic, wherein the second PPDU comprises a preamble that is compliant with the second 802.11 protocol and the small data traffic;
wherein a duration of the preamble that is compliant with the second 802.11 protocol is shorter than a duration of the preamble that is compliant with the first 802.11 protocol.

2. The rate control method as claimed in claim 1, wherein the first PPDU is an extremely high throughput (EHT) PPDU or a high efficiency (HE) PPDU, and the second PPDU is a very high throughput (VHT) PPDU.

3. The rate control method as claimed in claim 2, wherein a duration of a long training field (LTF) field in the HE PPDU or the EHT PPDU is longer than a duration of a LTF field in the VHT PPDU.

4. The rate control method as claimed in claim 2, wherein the HE PPDU or the EHT PPDU has a packet extension, and the VHT PPDU does not have a packet extension.

5. The rate control method as claimed in claim 1, wherein the step of determining whether the pending data traffic is large data traffic or small data traffic further comprises:
determining a ratio of a calculated length of a PPDU to a predefined PPDU maximum length, wherein the PPDU comprises the pending data traffic and a PPDU preamble, and the PPDU is compliant with the first 802.11 protocol or the second 802.11 protocol;
comparing the ratio with a threshold;
determining that the pending data traffic is large data traffic when the ratio is greater than the threshold; and
determining that the pending data traffic is small data traffic when the ratio is less than or equal to the threshold.

6. A rate control method with low power consideration for wireless dense networks, wherein the method is implemented by a wireless communication device, and comprises:
determining first power needed for transmission of an additional overhead of data traffic, wherein the additional overhead comprises an additional control signal required to complete a transmission of the data traffic;
determining a plurality of second powers needed for transmission of the data traffic, wherein the plurality of second powers correspond to a plurality of data rates of the data traffic;
selecting a data rate from the plurality of data rates based on the first power, the plurality of second powers and a plurality of packet error rates (PERs) that correspond to the plurality of data rates; and
transmitting a physical protocol data unit (PPDU), wherein the PPDU comprises the data traffic, and the data traffic is transmitted at the selected data rate.

7. The rate control method of claim 6, wherein the step of selecting a data rate from the plurality of data rates based on the first power, the plurality of second powers and the plurality of PERs that correspond to the plurality of data rates further comprises:
determining a plurality of total power consumptions corresponding to the plurality of data rates based on the first power, the plurality of second powers and the plurality of PERs that correspond to the plurality of data rates, wherein each second power needed for transmission of the data traffic is a product of a duration of the data traffic and transmission power of the data traffic; and
selecting the data rate that corresponds to a lowest total power consumption from the plurality of total power consumptions.

8. The rate control method of claim 7, wherein the step of determining first power needed for transmission of the additional overhead of data traffic further comprises:
determining a plurality of first powers needed for transmission of the additional overhead corresponding to a plurality of rates;
the step of determining the plurality of total power consumptions corresponding to the plurality of data rates based on the first power, the plurality of second powers and the plurality of PERs that correspond to the plurality of data rates further comprises:
determining the plurality of total power consumptions corresponding to the plurality of data rates based on the plurality of first powers, the plurality of second powers and the plurality of PERs that correspond to the plurality of data rates.

9. The rate control method of claim 7, wherein the additional overhead comprises a request-to-send (RTS) and a preamble of the PPDU.

10. The rate control method of claim 7, wherein the additional overhead only comprises a preamble of the PPDU.

11. The rate control method of claim 9, wherein the power needed for transmission of the RTS is a product of a duration of the RTS and transmission power of the RTS, and the power needed for transmission of the preamble of the PPDU is a product of a duration of the preamble and transmission power of the preamble;
wherein the first power needed for transmission of the additional overhead is the sum of the power needed for transmission of the RTS and the power needed for transmission of the preamble of the PPDU.

12. The rate control method of claim 6, further comprising:
determining actual power for transmitting the data traffic based on a channel condition;
wherein the data traffic in the PPDU is transmitted by using the actual power.

13. The rate control method of claim 6, wherein the PPDU comprises a number of spatial streams (NSS) field, a modulation and coding scheme (MCS) field, a bandwidth (BW) field, and a guard interval/long training field (GI/LTF) field; and
wherein at least one of the NSS field, the MCS field, the BW field and the GI/LTF field indicates the selected data rate.

14. A rate control device with low power consideration for a wireless network, comprising:
a processor; and
a transceiver operable to perform wireless transmission, wherein the processor is operable to:
build a connection with a second device by using a first 802.11 protocol;
determine whether pending data traffic is large data traffic or small data traffic;
transmit a first physical protocol data unit (PPDU) compliant with the first 802.11 protocol to the second device in response to determining that the pending data traffic is large data traffic, wherein the first PPDU comprises a preamble that is compliant with the first 802.11 protocol and the large data traffic; and
transmit a second PPDU compliant with a second 802.11 protocol to the second device in response to determining that the pending data traffic is small data traffic, wherein the second PPDU comprises a preamble that is compliant with the second 802.11 protocol and the small data traffic;
wherein a duration of the preamble that is compliant with the second 802.11 protocol is shorter than a duration of the preamble that is compliant with the first 802.11 protocol.

15. The rate control device as claimed in claim 12, wherein the first PPDU is an extremely high throughput (EHT) PPDU or a high efficiency (HE) PPDU, and the second PPDU is a very high throughput (VHT) PPDU; and
wherein the first 802.11 protocol is 802.11ax or 802.11be, and the second 802.11 protocol is 802.11ac.

16. The rate control device as claimed in claim 12, wherein the step of determining whether the pending data traffic is large data traffic or small data traffic further comprises:
determining a ratio of a calculated length of a PPDU to a predefined PPDU maximum length, wherein the PPDU comprises the pending data traffic and a PPDU preamble, and the PPDU is compliant with the first 802.11 protocol;
comparing the ratio with a threshold;
determining that the pending data traffic is large data traffic when the ratio is greater than the threshold; and
determining that the pending data traffic is small data traffic when the ratio is less than or equal to the threshold.

17. A rate control device with low power consideration for a wireless network, comprising:
a processor; and
a transceiver operable to perform wireless transmission, wherein the processor is operable to:
determine first power needed for transmission of an additional overhead of data traffic, wherein the additional overhead comprises an additional control signal required to complete a transmission of the data traffic;
determining a plurality of second powers needed for transmission of the data traffic;
select a data rate from the plurality of data rates based on the first power, the plurality of second powers and a plurality of packet error rates (PERs) that correspond to the plurality of data rates; and
transmit a physical protocol data unit (PPDU), wherein the PPDU comprises the data traffic, and the data traffic is transmitted at the selected data rate.

18. The rate control device of claim 17, wherein the step of selecting a data rate from the plurality of data rates based on the first power, the plurality of second powers and the plurality of PERs corresponding to the plurality of data rates further comprises:
determining a plurality of total power consumptions corresponding to the plurality of data rates based on the first power, the plurality of second powers and the plurality of PERs corresponding to the plurality of data rates, wherein each second powers needed for transmission of the data traffic is a product of a duration of the data traffic and transmission power of the data traffic; and
selecting the data rate corresponding to a lowest total power consumption from the plurality of total power consumptions.

19. The rate control device of claim 17, wherein the additional overhead comprises a request-to-send (RTS) and a preamble of the PPDU.

20. The rate control device of claim 19, wherein the power needed for transmission of the RTS is a product of a duration of the RTS and transmission power of the RTS, and the power needed for transmission of the preamble of the PPDU is a product of a duration of the preamble and transmission power of the preamble;
wherein the first power needed for transmission of the additional overhead is equal to the power needed for transmission of the RTS and the power needed for transmission of the preamble of the PPDU.
